(19) United States
(12) Patent Application Publication
(10) Pub. No.: US 2018/0336329 A1
(43) Pub. Date: Nov. 22, 2018

(54) Vehicle Steering Assembly

(71) Applicant: Lynn Walford, Pasadena, CA (US)

(72) Inventor: Lynn Walford, Pasadena, CA (US)

(21) Appl. No.: 15/600,659

(22) Filed: May 19, 2017

(51) Int. Cl. G06F 21/32; B60W 30/095; B32B 17/06; B60W 30/12; B60W 30/14; B62D 1/06

(52) U.S. Cl. CPC G06F 21/32; B60W 30/0956; B32B 17/064; G06K 9/00; B60W 30/146; B62D 1/06; B60W 30/12

(57) ABSTRACT

The present disclosure relates to a vehicle, comprising: a steering assembly, including: a hub; at least one spoke extending radially outward from the hub; a housing at least partially covering the hub and spoke; a rim attached to the spoke; a lighting element in light communication with the rim; and a biosensor coupled to any one of the housing and rim; and a vehicle control module linked to the steering assembly. The rim is at least partially transparent.

### CROSS-REFERENCE TO RELATED APPLICATIONS

This application is a continuation and claims the benefit of U.S. Provisional Patent Application Ser. No. 62/339,170 entitled “Secure Connected Transparent Steering Wheel with Driver Assistance through Sensation, Light, Color and Information” filed May 20, 2016, which is hereby incorporated by reference in its entirety.

### TECHNICAL FIELD

The present disclosure relates to vehicle steering assemblies and control modules for the same.

### BACKGROUND

There is a growing population of drivers over age 55 who require vision correction and/or hearing assistance. Most steering wheels in vehicles have limited functionality on the outer ring (or rim) where a driver's hands meet the steering wheel. When steering wheels are used by petite drivers their view of a fuel gauge, speedometer and/or other vehicle performance displays in the instrument cluster can be blocked by the steering wheel rim. Also, information displayed on the instrument cluster, center stack or any other displays in the vehicle may not be seen properly by drivers who require vision correction.

Current advanced driver assistance systems (or ADAS) such as lane departure warnings and forward collision warnings signal the driver through audible alerts, which may not be heard by hearing impaired drivers. Also, studies show that many drivers with ADAS features having audio warnings shut off the sound because it can become annoying over time.

As to vehicle security, there is furthermore a growing number of vehicle computer system hacks that use key fob transmissions to copy secure codes used to open or startup the vehicle.

Therefore, it is desirable to have a vehicle with improved visibility, communication of alerts/warnings and additional security metrics.

### SUMMARY

In one exemplary embodiment of the present disclosure a vehicle, includes: a steering assembly, including: a hub; at least one spoke extending radially outward from the hub; a housing at least partially covering the hub and spoke; a rim attached to the spoke; a lighting element in light communication with the rim; and a biosensor coupled to any one of the housing and rim; and a vehicle control module linked to the steering assembly. The rim is at least partially transparent.

In another embodiment of the present disclosure a vehicle steering assembly, includes: a control module linked to the steering assembly; a rim, at least partially transparent; and an actuator coupled to the rim and linked to the control module. The control module is configured to selectively generate a non-audible alert.

In another embodiment of the present disclosure a vehicle control module, includes: navigation logic configured to interface with a global positioning system and determine a vehicle location; security logic configured to selectively disable vehicle use; lighting logic configured to control a lighting element in light communication with a vehicle steering wheel; display logic configured to control a display coupled to the vehicle steering wheel; and driver assist logic configured to determine whether the vehicle is within boundaries of a traffic lane. Any one of the driver assist logic and navigation logic are further configured to control an actuator configured to selectively generate any one of vibrations and torqueing at the vehicle steering wheel.

One advantage of the teachings of the present disclosure is a connected steering wheel assembly with a transparent rim and embedded color changing lights. One embodiment of the steering wheel assembly additionally provides tactile/haptic vibrations, a display with vehicle performance information, biosensors and antitheft security. In some embodiments, the lighting of the steering wheel indicates when to slow, stop and go with colors that drivers of all ages understand.

### BRIEF DESCRIPTION OF THE DRAWINGS

Techniques will be explained in greater detail below by way of example with reference to the figures, in which the same reference numbers are used in the figures for identical or essentially identical elements. The above features and advantages and other features and advantages of the present disclosure are readily apparent from the following detailed description when taken in connection with the accompanying drawings. In the figures:

FIG. 1 is a front view of a vehicle steering assembly according to an exemplary embodiment of the present disclosure.

FIG. 2 is a rear view of the steering assembly of FIG. 1.

FIG. 3 is a side view of a lighting element according to an exemplary embodiment of the present disclosure.

FIG. 4 is a schematic of a vehicle control module according to an exemplary embodiment of the present disclosure.

FIG. 5 is a front view of a vehicle steering assembly according to another exemplary embodiment of the present disclosure.

FIG. 6 is a rear view of the steering assembly of FIG. 5.

### DETAILED DESCRIPTION

Referring to the drawings, wherein like characters represent the same or corresponding parts throughout the several views there is shown various embodiments of vehicle steering assemblies for use with a motor vehicle. The steering assemblies allow a driver to input directional information to the vehicle chassis and drivetrain. The present steering assemblies provide improved visibility, communication of alerts/warnings and additional security metrics.

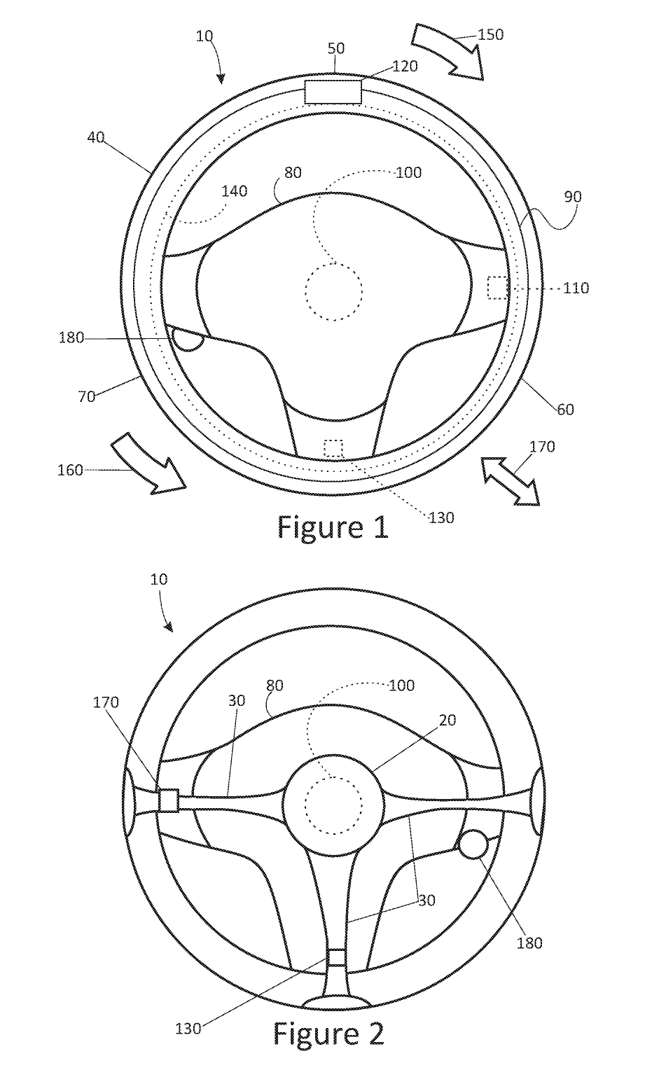

Referring now to FIG. 1, there is shown therein a front view of a vehicle steering assembly 10 according to an exemplary embodiment of the present disclosure. Steering assembly 10 attaches to a steering column linked to the vehicle drivetrain (not shown). The steering column attaches to the assembly 10 at hub 20 (as shown in FIG. 2). Three spokes 30 are included in this steering assembly 10, spokes are configured to extend radially outward from hub 20. Steering assembly 10, as shown in FIG. 1, includes an outer rim 40 segmented in three portions in this embodiment. Rim 40 has an upper portion 50, lower right portion 60 (near a passenger side of the vehicle) and lower left portion 70 (near a driver side of the vehicle). Rim 40 is composed of a material that is at least partially transparent. Rim 40 is connected to a housing 80 of the steering assembly 10 through spokes (30 as shown in FIG. 2). Rim 40 is in light communication with a lighting element 90 such that rim is configured to allow light to pass through the body of rim from one side of lighting element to the other side of lighting element, i.e., across at least an arc of rim like 50. In other embodiments, steering assembly includes multiple lighting elements, e.g., mounted at two or three points around the circumference of rim.

In the illustrated embodiment of FIG. 1, rim 40 is composed of a polycarbonate, e.g., Lexan. In yet another embodiment, rim 40 is composed of a synthetic sapphire. In other embodiments, other high strength polymers can be used, such as electroluminescent material like mylar or light tubing. In other embodiments, rim 40 can include light transmitting elements like incandescent materials, fiber optics or light emitting acrylics. Other exemplary transparent and semitransparent rim materials are disclosed for example in Chinese Patent Publication No. CN105644614A, entitled “Transparent Light-Emitting Colorful Steering Wheel;” Chinese Patent Publication No. CN205273593, entitled “Car Steering Wheel with Oil Mass or Quantity Indicating Lamp;” World Intellectual Property Organization Patent Publication No. WO2016150572, entitled “Movable or Deformable Touch Pad System Forming a Human-Machine Interface Suitable for a Vehicle Steering Wheel;” and Chinese Patent Publication No. CN204567763, entitled “Steering Wheel that has Steering Indicating Device” all of which are hereby incorporated by reference in their entireties.

As shown in FIG. 1, lighting element 90 is at least partially housed by housing 80. Housing 80 is journaled onto rim 40 at three locations in this embodiment. Housing 80 also includes a compartment for covering an airbag cartridge 100.

Steering assembly 10, of FIG. 1, includes a biosensor 110. Biosensor 110 can be a fingerprint sensor and/or biosensor can be configured to take measurements related to other driver biodata such as health statistics, e.g., blood alcohol level, blood sugar level, and blood pressure. On the back side of steering assembly 10, biosensor 110 is exposed to the driver (as shown in FIG. 2) such that placement of a driver finger on biosensor will enable a reading to take place. Sensor 110 is located at a position so that a middle finger of the left hand behind the steering wheel will naturally rest on sensor. Biosensor 110 can be placed anywhere on rim 40; e.g., in another embodiment biosensor 110 is positioned for right-hand use, i.e., near the passenger side of the vehicle.

Steering assembly 10 of FIG. 1 also includes a display 120. Display 120 is coupled to rim 40 in this embodiment. This placement of display 120 is closer than the traditional location of a display in, e.g., an instrument panel/cluster. Display 120 is configured to display vehicle information to the driver. Any sort of display can be used including an LCD display, projected images or heads up displays or easy to read E-ink (or electronic paper display) or daylight-readable Interferometric modulator display (IMOD), for example for example. Other displays compatible with the present teachings are disclosed for example in World Intellectual Property Organization Patent Publication No. WO2017049526 entitled “Automobile Display System;” US Patent Publication No. 20140111736 entitled “Curved Display Apparatus;” and US Patent Publication No. 2014/0301097 entitled “Steering Wheel Assembly for a Motor Vehicle” all of which are hereby incorporated by reference in their entireties.

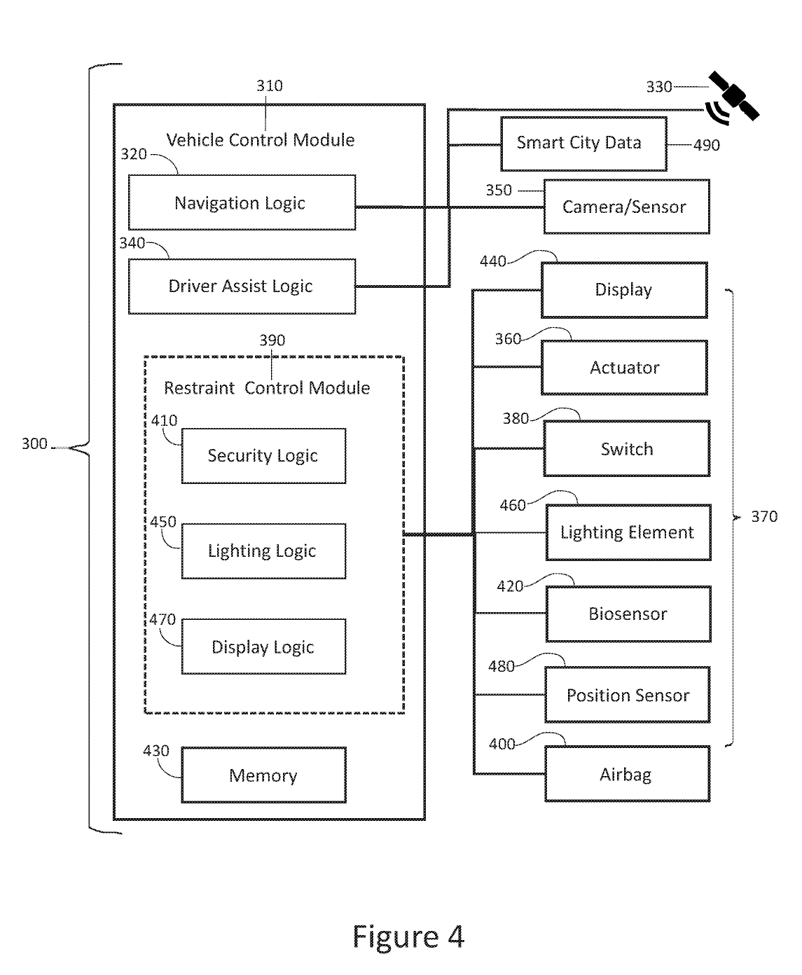

Steering assembly 10 of FIG. 1 also includes a position sensor 130. Position sensor 130 is configured to determine a position of the rim 40 and transmit rim-position data to a control module (e.g., 310 as shown in FIG. 4). In the embodiment of FIG. 2, position sensor 130 is an accelerometer and gyroscope configured to determine the acceleration of the rim 40 as well as the angular position of the rim. In other embodiments, position sensor 130 is configured to assess distance of vehicle travel, vehicle acceleration and/or vehicle speed.

Steering assembly 10 of FIG. 1 is configured to provide tactile or haptic feedback to a driver. Assembly 10 includes an actuator 140 linked to a vehicle control module (310 as discussed with respect to FIG. 4). Actuator 140 of FIG. 1 is configured to selectively generate vibrations and torqueing at the rim 40 of the steering assembly when instructions for the same are received from the vehicle control module (310 as shown in FIG. 4). These are non-audible or predominantly inaudible alerts. Actuator 140 of FIG. 1 includes a motor (not shown). Actuator 140 can generate a torque in a clockwise direction with respect to the front view of the assembly 150 or a torque in a counterclockwise direction with respect to the front view of the assembly 160. Actuator 140 is also configured to generate a vibration or oscillation in any one of a radial 170, circumferential or otherwise linear direction with respect to the front view of the assembly 10. A switch 180, as shown in FIGS. 1 & 2, is incorporated into assembly 10, attached to housing 80, and configured to control the output level of actuator 140. In this embodiment, switch 180 is a dial that controls the resistance between the actuator 140 and a power source (not shown) like a vehicle SLI (starting lighting ignition) battery or an independent battery. Actuator 140 can be positioned anywhere on rim 40; e.g., in another embodiment actuator is position on the driver side of rim.

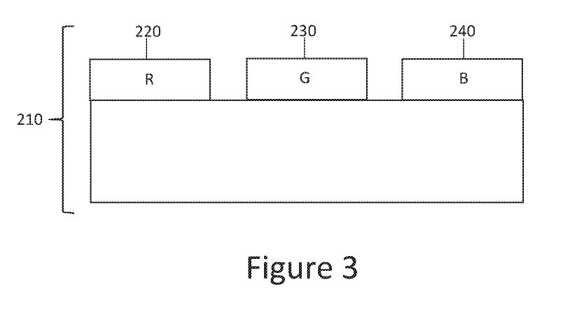

Now referring to FIG. 3, there is shown a side view of a lighting element 200 according to an exemplary embodiment of the present disclosure. Lighting element 200 can be used with the steering assembly 10 of FIG. 1. In FIG. 3, there is shown a printed circuit board 210 having three light sources connected thereto 220, 230 and 240, respectively. Light sources 220, 230 and 240 in this embodiment are LEDs (or light emitting diodes). In other embodiments, other light sources are used, such as for example organic LEDs or incandescent bulbs. As shown in FIG. 3, light source 220 is configured to emit a red light, light source 230 is configured to emit a yellow light and light source 240 is configured to emit a blue light. Circuit board 210 can switch either light source 220, 230 or 240 on or off in solidarity or in combination. Accordingly, all of the colors of the rainbow can be achieved, such as the traditional traffic colors of red, yellow and green, as discussed hereinbelow. In other embodiments, other colored light sources can be used, e.g., white or ultraviolent lights. These are non-audible or predominantly inaudible alerts. Other exemplary lighting elements are compatible such as those disclosed, for example, in Chinese Patent Publication No. CN106043118A, entitled “Automobile Steering Wheel Sleeve System;” and U.S. Pat. No. 8,136,425 entitled “Back Light of Steering Wheel” which are hereby incorporated by reference in their entireties.

With reference to FIG. 4, there is shown therein a schematic of a vehicle 300 having a vehicle control module (or unit) 310 according to an exemplary embodiment of the present disclosure. Vehicle control module 310 is configured to control several steering wheel functions. Any one of the logics referred to with respect to FIG. 4 can be included in the vehicle control module 310 or other modules linked to the vehicle control module. In the embodiment of FIG. 4, vehicle control module 310 includes navigation logic 320. Navigation logic 320 is configured to interface with a global positioning system (e.g., a GPS satellite system 330 external to the vehicle 300 as partially shown) to determine vehicle location. In some embodiments, navigation logic 320 can determine whether a turn instruction is forthcoming based upon downloaded or calculated directions. In other embodiments, navigation logic 320 can determine the location and status of traffic signals with respect to vehicle location. Such information is relayed to the vehicle control module 310. Navigation logic 320 is configured to interface with Smart City Data 490 (such as traffic, accidents, road repairs etc.) to calculate the most efficient route. Vehicle control module 310 of FIG. 4 further includes driver assist logic 340. Driver assist logic 340 is linked to navigation logic 320. Driver assist logic 340 is configured to determine whether the vehicle 300 is within boundaries of a traffic lane (not shown) or whether a vehicle trajectory will place the vehicle outside of said boundaries inadvertently or without a turn signal being activated. Driver assist logic 340 is linked to a vehicle camera/sensor 350 (such as radar or sonar) that reads images in front of the vehicle like stop signs, speed limit signs, vehicle distance from other objects and lane markers. Such information is relayed to the vehicle control module 310. Driver assist logic 340 is linked to Smart City Data 490 that provides traffic information and alerts (such as disasters, road construction or traffic situations). Driver assist logic 340 (and/or vehicle control module 310) is also configured to activate an actuator 360 located in a steering assembly 370 under predetermined conditions. In one embodiment, the predetermined condition is the vehicle 300 deviating from the boundaries of a traffic lane. When this predetermined condition is met, driver assist logic 340 is configured to send a signal to actuator 360 to apply a directional torque so as to turn the rim of the steering assembly in a direction opposite to an existing direction of travel. So, if the vehicle is deviating from a traffic lane to the right, driver assist logic 340 will apply a corrective torque to the left and vice versa. A switch 380 is linked to the vehicle control module 310 (and/or actuator 360) configured to control the output level of the actuator, i.e., turning the intensity of actuator vibrations up or down. Switch 380 can be any number of control devices, for example, as disclosed in U.S. Pat. No. 8,987,620 entitled “Haptic Steering Wheel Switch Apparatus” which is hereby incorporated by reference in its entirety. Other exemplary driver assist algorithms for trajectory correction, grip pressure detection, driver attentiveness and/or lane-departure warning can be stored in the vehicle control module, for example, as disclosed in US Patent Publication No. US20170021854 entitled “Steering Wheel;” Chinese Patent Publication No. CN106043314, entitled “Lane Departure Warning Method and Device Based on Vibration of Steering Wheel;” US Patent Publication No. US20150269829 entitled “Method and Apparatus for Maintaining Alertness of an Operator of a Manually-Operated System;” US Patent Publication No. US20150217687 entitled “Steering Wheel Cover with Driver Alert System;” US Patent Publication No. US20130032002 entitled “Vibration Arrangement for a Vehicle Steering Wheel;” Japanese Patent Publication No. JP2013244767 entitled “Lane Departure Warning Device, Vehicle Mounted with the Same, and Method for Controlling the Same;” and Korean Patent Publication No. KR20130070695 entitled “Installing Structure of Vibrator for Warning Apparatus of Traffic Lane Escape” all of which are hereby incorporated by reference in their entireties.

In another embodiment, the predetermined condition is arrival at a navigated destination. When this predetermined condition is met, navigation logic 320 is configured to send a signal to the actuator 360 to apply a directional torque so as to turn the rim in a direction of desired travel. So, for example, where navigation logic 320 sends a right turn instruction to the vehicle control module 310, navigation logic will also send a signal to actuator 360 to torque the rim clockwise (as shown in FIG. 1), thereby alerting the driver of the need to turn right.

With further reference to FIG. 4, vehicle control module 310 includes a restraint control module 390. Restraint control module 390 is linked to navigation logic 320 and driver assist logic 340. Restraint control module 390 is primarily responsible for governing the functionality of vehicle restraints such as an airbag 400. Additionally, as shown, restraint control module 390 includes security logic 410 configured to selectively disable vehicle use. In one embodiment, security logic 410 disables vehicle use by opening a switch between the SLI battery and the vehicle startup system (not shown). In another embodiment, security logic 410 applies a lock to the steering wheel. Connected to security logic 410 is a biosensor 420. In one embodiment, biosensor 420 is a fingerprint scanner/sensor. Vehicle control module 310 is configured to store driver biodata in a memory (430 as shown in FIG. 4) of the vehicle control module. The driver biodata in this embodiment is a stored fingerprint scan. Security logic 410 is configured to compare a fingerprint scan with the stored fingerprint scan upon each vehicle startup to ensure that only preapproved drivers use the vehicle 300. Security logic 410 is configured to disenable vehicle use when said fingerprint scan does not match a stored fingerprint scan. In this way, fingerprint sensor 420 has a security (or antitheft) function. Restraint control module 390 or security logic 410 is configured with a fingerprint comparison algorithm to assess whether a newly scanned fingerprint matches pre-approved scanned fingerprints. An exemplary fingerprint comparison algorithm is disclosed in U.S. Pat. No. 9,613,251 entitled “Fingerprint Matching Algorithm,” which is hereby incorporated by reference in its entirety. Should the newly scanned fingerprint image be validated by the restraint control module 390 the vehicle start system is activated, e.g., the ignition is linked to the vehicle starter. Any number of different fingerprint scanners can be used including, for example, those disclosed in Chinese Patent Publication No. CN205601789, entitled “Theftproof Steering Wheel and Car with Touch-Control Function” and Chinese Patent Publication No. CN205706590 entitled “Automobile Intelligent Antitheft System” which are hereby incorporated by reference in their entireties. Vehicle will not start without a registered fingerprint. In one embodiment, fingerprint sensor 420 and security logic 410 doubles as an activation switch for the steering display 440 as well, disconnecting power to the display until after verification.

In another embodiment, biosensor 420 is a perspiration monitor. Memory 430 has stored therein predetermined thresholds for driver health conditions, e.g., a blood alcohol level. Security logic 410 is configured to compare a perspiration reading from the perspiration monitor (or biosensor 420) with the predetermined threshold and disenable vehicle use when said perspiration reading is outside of the predetermined threshold. In other embodiments, biosensor 420 is configured to detect any number of driver health conditions such as heartrate, blood sugar/glucose levels, blood alcohol levels, aggression, drowsiness, and temperature. Should any of the health parameters exceed a predetermined threshold, restraint control module 390 is configured to send a signal to the vehicle control module 310 to disenable vehicle operation. For example, the switch between the ignition and vehicle starter (not shown) can be fixed in the off position. In another embodiment, the steering wheel can be locked into place when biosensor 420 detects a health parameter outside of its predetermined value. In one embodiment, vehicle control module 310 is configured with communication capabilities to signal a call processing center or emergency responders. Where security logic 410 disenables vehicle use a signal can be sent or call can be placed automatically to the call processing center. Biosensor 420 can be any kind of single sensor or combination of sensors. In one embodiment, biosensor 420 is an infrared photoelectric sensor configured to detect blood pressure. In another embodiment, biosensor is a semipermeable membrane that detects health conditions through human sweat. German Patent Publication No. DE19959576 entitled “Device for Monitoring Physiological Parameters of Driver of Motor Vehicle, Uses Sensor E.g., on Steering Wheel to Measure Skin Resistance, Blood Sugar Level Etc.” is hereby incorporated by reference in its entirety. Other biosensors or scanners are compatible with the steering assembly such as those disclosed for example in Chinese Patent Publication No. CN205674871, entitled “Driver Safety Protection System;” Chinese Patent Publication No. CN205751145, entitled “Can Prevent Driver Fatigue's Driver Assistance System;” Chinese Patent Publication No. CN105852887, entitled “Steering Wheel and System and Method for Detecting Fatigue”; Chinese Patent Publication No. CN204801861, entitled “Car Steering Wheel with Health Detects Function”; German Patent Publication No. DE102009021138 entitled “Intelligent Steering Wheel for Car, has Sensors Connected with Electrical System by Appropriate Software for Evaluation Purpose, where Sensors Detect Pulse, Temperature, Hand Humidity and Bloodless Measurement of Blood Sugar Level”; and World Intellectual Property Organization Patent Publication No. WO9425945 entitled “Biological Fitness Monitor for Motor Vehicle Operators” all of which are hereby incorporated by reference in their entireties.

Vehicle control module 310 of FIG. 4 further includes lighting logic 450 configured to control a lighting element 460. Lighting logic 450 is in communication with driver assist logic 340 and navigation logic 320 of FIG. 4. In one embodiment, driver assist logic 340 is further configured to assess a local speed limit and determine if the vehicle is exceeding said local speed limit. Lighting logic 450 is configured to activate lighting element 460 when the vehicle is exceeding said local speed limit. Lighting element 460 can be configured to emit various colors or sequences of lighting displays including, for example, flashing lights or a yellow or red light to indicate caution. Lighting logic 450 is configured to selectively activate any one of a plurality of light sources (e.g., 220, 230 and 240 as shown in FIG. 3) in unison, consecutively or singularly. In one embodiment, the steering wheel assembly 370 of FIG. 4 connects via vehicle control module 310 to advanced telematics systems having data such as city infrastructure and mapping information to guide a driver to destinations. Based upon this information, lighting logic 450 is configured to have steering wheel assembly 370 glow with, e.g., a yellow light when a traffic light turns yellow or when in a construction zone as the vehicle is connected to “smart city” traffic infrastructure or when navigation software indicates the driver should slow down. Lighting logic 450 is configured to make the steering wheel assembly 370 turn red at a stop sign when, e.g., cameras 350 detect a stop sign. In one embodiment, the steering wheel light color also changes to yellow when Smart City Data 490 indicates heavy traffic forthcoming.

In some embodiments, a combination of alerts can be used to convey information to a driver. For example, in one embodiment, vehicle control module 310 is configured so that steering wheel assembly 370 vibrates slowly and glows yellow when approaching a speed limit. Yellow, red and green lights warn to slow, stop and go, respectively.

In other embodiment, driver assist logic 340 is configured to transmit forward collision warnings to vehicle control module 310. In the event of a pending forward collision, steering wheel assembly 370 assembly pulses radially. Lighting logic 450 controls lighting element 460 to display flashing lights for forward collision warning. In another embodiment, lighting element 460 includes directional lights configured to flash sequentially to indicate a direction to turn the steering wheel rim. In another embodiment, actuator 360 pulses can also be configured to act as guidance for parallel parking, angled parking or backing up. In yet another embodiment, where driver assist logic 340 notices a pending curve ahead that is inconsistent with the current vehicle trajectory, driver assist logic will notify a driver of the need to turn the steering wheel rim by sending a signal to the actuator 360 to generate slow pulses at the rim and/or torques in the intended direction of travel. Another embodiment includes a lighting element configured to change to other colors such as white, pink, purple, blue or a rainbow to indicate a warning, direction, set a mood or aesthetically match an interior design theme.

Vehicle control module 310 of FIG. 4 further includes display logic 470 configured to control a display 440 coupled to the vehicle steering wheel assembly 370. Display logic 470 is configured to translate vehicle performance information like speed, direction, and fuel level to display 440 for driver notification.

A position sensor, 480 of FIG. 4, is also linked to vehicle control module 310 and incorporated in the steering assembly 370. Position sensor 480 is configured to determine any one of a vehicle/rim speed, position or acceleration. Position sensor 480 conveys this information to vehicle control module 310. In one embodiment, position sensor 480 is configured to determine a position of the rim (e.g., 40 as shown in FIG. 1) and transmit rim-position data to the vehicle control module 310 of FIG. 4. Should the angular position of rim change with too great of frequency in a given time, driver assist logic 340 will send a signal to the restraint control module 390 and/or lighting logic 450 to illuminate a warning in order to check driver attentiveness. Information from the position sensor 480 also informs display logic 470 of the orientation of the display 440 so as to change the orientation of displayed images when so desired, e.g., as disclosed in US Patent Publication No. 20140062891 entitled “Steering Wheel with Rotatable Display and Fixed/Movable Images” which is hereby incorporated by reference in its entirety.

Vehicle control module 310 also includes a writable/readable memory 430, as shown in FIG. 4. Vehicle control module 310 is configured to store driver-steering habits in the memory 430. Vehicle control module 310 is also configured to store driver biodata such as fingerprints or health information received from biosensor 420 in the memory 430.

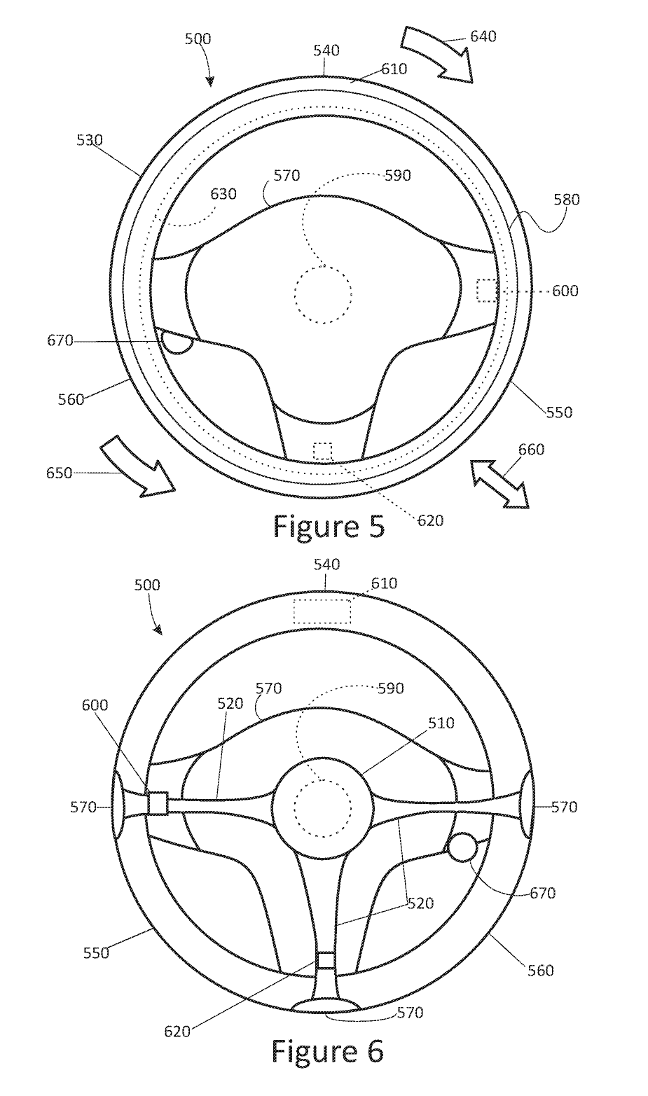

Referring now to FIG. 5, there is shown therein a front view of another exemplary embodiment of a vehicle steering assembly 500. Steering assembly 500 attaches to a steering column linked to the vehicle drivetrain (not shown). The steering column attaches to the assembly 500 at hub 510 (as shown in FIG. 6). Three spokes 520 are included in this steering assembly 500, spokes are configured to extend radially outward from hub 510. Steering assembly 500, as shown in FIG. 5, includes an outer rim 530 segmented in three portions in this embodiment. Rim 530 has an upper portion 540, lower right portion 550 (near a passenger side of the vehicle) and lower left portion 560 (near a driver side of the vehicle). Rim 530 is composed of a material that is at least partially transparent. Rim 530 is connected to a housing 570 of the steering assembly 500 through spokes (520 as shown in FIG. 6). Rim 530 is in light communication with a lighting element 580 configured to act as a backlight to rim.

In the illustrated embodiment of FIG. 5, rim 530 is composed of a high-grip polymer having a textured surface. As shown in FIG. 5, lighting element 580 is at least partially housed in rim 530 and housing 570. Housing 570 is journaled onto rim 530 at three locations in this embodiment. Housing 570 also includes a compartment for covering an airbag cartridge 590.

Steering assembly 500, of FIG. 5, includes a biosensor 600. Biosensor 600 can be a fingerprint sensor and/or biosensor can be configured to take measurements related to other driver biodata such as health statistics, e.g., blood alcohol level, blood sugar level, and blood pressure. On the back side of steering assembly 500, biosensor 600 is exposed to the driver (as shown in FIG. 6) such that placement of a driver finger on biosensor will enable a reading to take place. Sensor 600 is located at a position so that a middle finger of the right hand behind the steering wheel will naturally rest on sensor.

Steering assembly 500 of FIG. 5 also includes a display 610. Display 610 is coupled to rim 530 in this embodiment. This placement of display 610 is closer than the traditional location of a display in, e.g., an instrument panel/cluster. Display 610 is configured to display vehicle information to the driver. Any sort of display can be used including an LCD display, projected images or heads up displays or easy to read E-ink (or electronic paper display), or daylight-readable Interferometric modulator display (IMOD), for example.

Steering assembly 500 of FIG. 5 also includes a position sensor 620. Position sensor 620 is configured to determine a position of the rim 530 and transmit rim-position data to a control module (e.g., 310 as shown in FIG. 4). In the embodiment of FIG. 6, position sensor 620 is an accelerometer and gyroscope configured to determine the acceleration of the rim 530 as well as the angular position of the rim.

Steering assembly 500 of FIG. 5 is configured to provide tactile or haptic feedback to a driver. Assembly 500 includes an actuator 630 linked to a vehicle control module (310 as discussed with respect to FIG. 4). Actuator 630 of FIG. 5 is configured to selectively generate vibrations and torqueing at the rim 530 of the steering assembly 500 when instructions for the same are received from the vehicle control module (310 as shown in FIG. 4). These are non-audible or predominantly inaudible alerts. Actuator 630 can generate a torque in a clockwise direction with respect to the front view of the assembly 640 or a torque in a counterclockwise direction with respect to the front view of the assembly 650. Actuator 630 is also configured to generate a vibration or oscillation in any one of a radial 660, circumferential or otherwise linear direction with respect to the front view of the assembly 500. A switch 670, as shown in FIGS. 5 & 6, is incorporated into assembly 500, attached to housing 570, and configured to control the output level of actuator 630. In this embodiment, switch 670 is a dial that controls the resistance between the actuator 630 and a power source (not shown) like a vehicle SLI (starting lighting ignition) battery or an independent battery. Actuator 630 can be positioned anywhere on rim 530; e.g., in another embodiment actuator is position on the driver side of rim.

US Patent Publication No. 20120296528 entitled “Haptic Steering Wheel, Steering-Wheel System and Driver Assistance System for a Motor Vehicle”; US Patent Publication No. 20160200246 entitled “Steering Wheel Light Bar”; and U.S. Pat. No. 8,880,287 entitled “Steering-Wheel-Hold Detection for Lane Keeping Assist Feature” are also hereby incorporated by reference in their entireties.

Methods of manufacturing a vehicle steering assembly are also contemplated by the present teachings. One embodiment of the method includes the steps of: (i) forming a hub; (ii) forming at least one spoke to extend radially outward from the hub; (iii) at least partially covering the hub and spoke with a housing; (iv) attaching an at least partially transparent rim to the spoke; (v) placing a lighting element in light communication with the rim; (vi) coupling a biosensor to any one of the housing and rim; and (vii) linking a vehicle control module to the steering assembly. The rim (and other formed components) can be formed by any number of processes like stamping, injection molding, pressure forming, laser cutting, 3D printing, lathing, and casting.

When elements are referred to as “coupled” in the present disclosure it can mean directly or indirectly connected. Any sort of fastener can be used to facilitate connection including for example, screws, rivets, adhesives, press-fitting and welds.

When modules and elements are referred to as “linked” in the present disclosure it can mean directly or indirectly connected through hard wired or wireless connections. To facilitate wireless communication, any number of wireless communication standards can be used such as Bluetooth, radio, or other IEEE standards. Any one of the modules or elements can include transmitters, receivers or transceivers to facilitate wireless communication.

The phrase “logic” can be used interchangeably with program, software or algorithm. Logics as discussed herein can be stored within a circuit or system having a processor with memory (e.g., any type of ROM or RAM). The logics can be programmed using any data management software with graphical interface capacity including, for example, C#, html, Java, Pascal, Caretta, or Basic.

While some modes for carrying out the disclosed techniques have been described in detail, those familiar with the art to which this area of technology pertains will recognize various alternative designs and embodiments for practicing the disclosed techniques.

We claim:

1. A vehicle, comprising:
a steering assembly, including:
a hub;
at least one spoke extending radially outward from the hub;
a housing at least partially covering the hub and spoke;
a rim attached to the spoke;
a lighting element in light communication with the rim; and
a biosensor coupled to any one of the housing and rim; and
a vehicle control module linked to the steering assembly;
wherein the rim is at least partially transparent.

2. The vehicle of claim 1, wherein the steering assembly further comprises:
an actuator linked to the vehicle control module and configured to selectively generate any one of vibrations and torqueing at the rim of the steering assembly.

3. The vehicle of claim 2, further comprising:
a switch coupled to any one of the housing and rim;
wherein the switch is configured to control an output level of the actuator.

4. The vehicle of claim 1, further comprising:
a display coupled to any one of the housing and rim;
wherein the display is linked to the vehicle control module.

5. The vehicle of claim 1, further comprising:
memory linked to the vehicle control module;
wherein said vehicle control module is configured to store driver-steering habits in said memory.

6. The vehicle of claim 5, wherein said vehicle control module is configured to store driver biodata in said memory.

7. The vehicle of claim 6, wherein the vehicle control module further comprises:
navigation logic configured to interface with a global positioning system and determine vehicle location;
security logic configured to selectively disable vehicle use;
lighting logic configured to control lighting element; and
driver assist logic configured to determine whether the vehicle is within boundaries of a traffic lane;
wherein any one of the driver assist logic and navigation logic are further configured to activate the actuator under predetermined conditions.

8. The vehicle of claim 7, wherein said biosensor is a fingerprint scanner and said driver biodata is a stored fingerprint scan; and
wherein said security logic is configured to compare a fingerprint scan with the stored fingerprint scan;
wherein said security logic is configured to disenable vehicle use when said fingerprint scan does not match the stored fingerprint scan.

9. The vehicle of claim 7, wherein said biosensor is a perspiration monitor; and
wherein said security logic is configured to compare a perspiration reading from said perspiration monitor with a predetermined threshold;
wherein said security logic is configured to disenable vehicle use when said perspiration reading is outside of the predetermined threshold.

10. The vehicle of claim 7, wherein the driver assist logic is further configured to assess a local speed limit and determine if the vehicle is exceeding said local speed limit; and
wherein the lighting logic is configured to activate the lighting element when the vehicle is exceeding said local speed limit.

11. The vehicle of claim 7, wherein a first predetermined condition is vehicle deviation from boundaries of the traffic lane; and
wherein when said first predetermined condition is met, said driver assist logic is configured to send a signal to the actuator to apply a directional torque so as to turn the rim in a direction opposite to an existing direction of travel.

12. The vehicle of claim 11, wherein a second predetermined condition is arrival at a navigated destination; and
wherein when said second predetermined condition is met, said navigation logic is configured to send a signal to the actuator to apply a directional torque so as to turn the rim in a direction of desired travel.

13. The vehicle of claim 1, wherein the lighting element includes a plurality of light sources; and
wherein the lighting logic is configured to selectively activate any one of the plurality of light sources.

14. A vehicle steering assembly, comprising:
a control module linked to the steering assembly;
a rim, at least partially transparent; and
an actuator coupled to the rim and linked to the control module;
wherein the control module is configured to selectively generate a non-audible alert.

15. The vehicle steering assembly of claim 14, further comprising:
a lighting element in light communication with the rim;
wherein the control module includes lighting logic configured to control lighting element.

16. The vehicle steering assembly of claim 15, further comprising:
a display coupled to the rim;
wherein the display is linked to the control module.

17. The vehicle steering assembly of claim 16, further comprising:
a switch coupled to the rim;
wherein the switch is configured to control an output level of the actuator.

18. The vehicle steering assembly of claim 17, further comprising:
a biosensor coupled to the rim and linked to the control module.

19. The vehicle steering assembly of claim 18, further comprising:
a position sensor configured to determine a position of the rim and transmit rim-position data to the control module.

20. A vehicle control module, comprising:
navigation logic configured to interface with a global positioning system and determine a vehicle location;
security logic configured to selectively disable vehicle use;
lighting logic configured to control a lighting element in light communication with a vehicle steering wheel;
display logic configured to control a display coupled to the vehicle steering wheel; and
driver assist logic configured to determine whether the vehicle is within boundaries of a traffic lane;
wherein any one of the driver assist logic and navigation logic are further configured to control an actuator configured to selectively generate any one of vibrations and torqueing at the vehicle steering wheel.
